(19) United States
(12) Patent Application Publication
(10) Pub. No.: US 2026/0248687 A1
(43) Pub. Date: Aug. 27, 2026

(54) CANNULA LOADING FIXTURE SYSTEM

(71) Applicant: ClearPoint Neuro, Inc., Solana Beach, CA (US)

(72) Inventor: Nathan Williams, San Diego, CA (US)

(21) Appl. No.: 19/542,020

(22) Filed: Feb. 17, 2026

Related U.S. Application Data
(60) Provisional application No. 63/760,000, filed on Feb. 18, 2025.

(51) Int. Cl. A61J 1/20

(52) U.S. Cl. CPC A61J 1/201

(57) ABSTRACT

A system fixedly positions a medical device relative to a target device. The system inlcudes a frame having a mounting location for mounting the medical device in a position relative to the frame such that the medical device extends along a predetermined trajectory. A portion of the medical device is positioned in a fixed, predetermined position relative to the target device. A guide element attaches to the frame and to the medical device. The guide element attaches the medical device to the mounting location of the frame in the position.

### CROSS REFERENCE TO RELATED APPLICATIONS

The present application claims priority to U.S. Provisional Application No. 63/760,000, filed on Feb. 18, 2025, and entitled “CANNULA LOADING FIXTURE SYSTEM,” the entirety of which is incorporated by reference herein.

### BACKGROUND

There is a need for systems and methods of aligning a medical device with one or more other devices such as a medical vial.

### SUMMARY

Disclosed is a medical device fixture system configured to hold a medical device in a defined trajectory relative to a device such as a medical vial. In an implementation, the disclosed system and associated workflow precisely align a trajectory and position of a cannula relative to a vial, such as to align and position a distal tip of the cannula inside of the vial for loading the cannula with fluid from the vial. This ensures the distal tip is at a desired location relative to the vial and does not get damaged from unintended interactions. In an example implementation, the disclosed system and workflow can be used for front-loading the cannula such as for aspirating therapy into the distal tip of the cannula.

In one aspect, there is disclosed a system for fixedly positioning a medical device relative to a target device, the system comprising: a frame having a mounting location for mounting the medical device in a position relative to the frame such that the medical device extends along a predetermined trajectory and a portion of the medical device is positioned in a fixed, predetermined position relative to the target device; and a guide element that attaches to or is incorporated in the frame and to the medical device, the guide element configured to attach the medical device to the mounting location of the frame in the position.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

FIG. 1 shows an example medical device fixture system.

FIG. 2 shows a vial holder of the medical device fixture system.

FIG. 3 shows a guide tube of the medical device fixture system.

FIG. 4 shows a guide adapter of the medical device fixture system.

FIG. 5 shows a depth stop of the medical device fixture system.

FIGS. 6 and 7 show example dimensions of the medical device fixture system.

FIGS. 8-14 show example steps of a workflow.

FIGS. 15-18 show example cannula height adjustment mechanisms.

### DETAILED DESCRIPTION

Before the present subject matter is further described, it is to be understood that this subject matter described herein is not limited to particular embodiments described, as such may of course vary. It is also to be understood that the terminology used herein is for the purpose of describing particular embodiments only and is not intended to be limiting. Unless defined otherwise, all technical terms used herein have the same meaning as commonly understood by one skilled in the art to which this subject matter belongs.

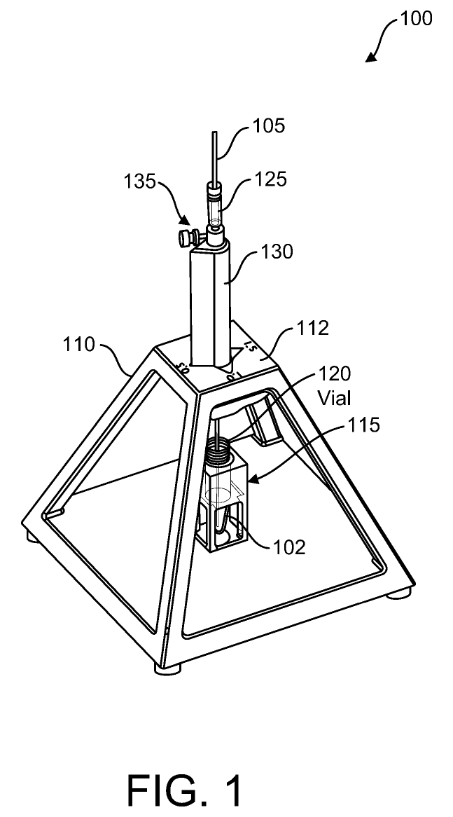

FIG. 1 shows an example implementation of a fixture system 100 that is configured to fix a position and/or orientation of a medical device relative to a second device such as, for example, a therapeutic vial. In a non-limiting example, the system is used to load fluid from a vial into a medical device comprising a cannula. The medical device is described herein as a cannula 105 although the medical can vary and can be, for example, a cannula, catheter, needle, biopsy needle, laser applicator, IVUS catheter, or any other medical device. In an implementation, the medical device is an elongated body that extends along a straight, curved or curvilinear axis.

The fixture system 100 can be used to store the cannula 105 before, during or after use with the medical device. The fixture system 100 includes a frame 110 that mechanically interacts with the cannula 105 to position the cannula 105 to form a defined alignment/trajectory along which that the cannula 105 is oriented (such as relative to a vial, as described below.) The trajectory may be a straight trajectory although it may also be curved or curvilinear. FIG. 1 shows the frame 110 as having a truncated pyramid shape with four struts that extend diagonally upward from a base and that form into a truncated upper platform 112 that serves as a mounting location for mounting the cannula to the frame 110. When mounted, the cannula extends along a predetermined trajectory and a portion of the cannula, such as a distal tip, can be positioned in a fixed, predetermined position relative to a target device such a vial 102.

The shape and structural configuration of the frame can vary. For example, the pyramid shape can be three-sided, four-sided, five-sided, etc. and the shape of the frame can vary from a pyramid. FIG. 1 shows a frame open on four sides for easy viewing and access. Alternatively, the frame may not be open on all sides. The frame may also be contained within an enclosure. The frame is illustrated as a unibody, but it may also be multiple pieces that are assembled. The pieces may be pre-assembled or constructed by the user. The assembly method may include snapping, sliding, folding or bolting.

With reference still to FIG. 1, the frame 110 is also mechanically coupled to a vial holder 115 that holds or otherwise mechanically couples to a container, such as the vial 102, bottle, ampule or other such container. FIG. 1 shows the vial mounted within the vial holder 115. The fixture system 100 holds the vial 120 (via the vial holder 115) in a position that can be positioned and oriented along the same alignment/trajectory as the cannula 105 such that a distal tip of the cannula 105 is pre-positioned to enter the vial when the cannula 105 placed into the fixture system 100. For example, the vial is positioned such that the distal tip of the cannula 105 is pre-positioned to enter an upper opening of the vial.

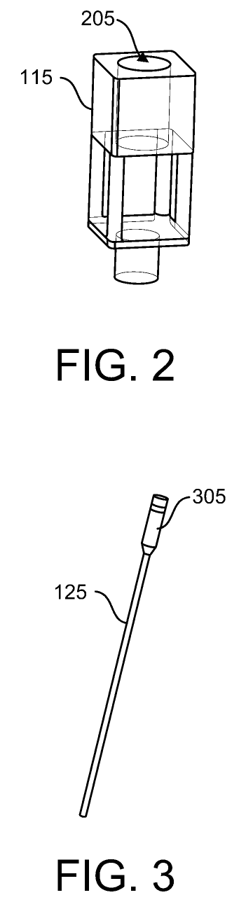

FIG. 2 shows an enlarged view of the vial holder 115, which is a frame or container that defines an internal seat 205 (such as a chamber) sized and shaped to receive the vial 120. The vial holder 115 can vary in shape and structure. Although showed as a prismatic shape, the vial holder 115 can have other geometries (e.g. 3-sided, 5-sided, circular). Also, the vial holder 115 is shown with a peg on the bottom that mates with the frame 110 to mount within and align it to the frame 110. Such a peg may be a different shape to provide radial alignment and may include a taper, chamfer or other feature to simplify mounting. For example, the peg may insert into a complementary-shaped opening of the frame 110. The vial holder 115 may also be mounted on the frame 110 via a variety of other features including a cutout, magnets, threading (i.e. screw in), set screw, etc. The vial holder may also be permanently attached and/or incorporated into the frame 110. The vial holder 115 may have a loose fit with the vial 102 to facilitate ‘drop in’ loading. Alternatively, the vial holder 115 may have a press fit or another mechanism to secure the vial 102 in the vial holder 115.

The vial holder 115 is shown as having a set geometry. Multiple vial holder options may be provided for compatibility with various vial sizes. Alternatively, the vial holder 115 may be configured such that it works with various vials (e.g. by incorporating tapered or expandable walls.) The frame 110 may also incorporate multiple vial holder options that can be selected by the user (e.g. by sliding or rotating a table.). The illustrated vial holder geometry is exemplary only. The vial holder 115 may have a different window configuration or include 1 wall to provide a ‘backdrop’ to view the vial. The vial holder 115 as shown includes large flat surfaces for finger grips, but these may be a different geometry including protrusions, grooves, etc.

With reference again to FIG. 1, the cannula 105 is removably positioned within a structure such as a guide tube 125. FIG. 3 shows the guide tube 125, which is an elongated body having an enlarged, proximal head 305 and an internal lumen that receives the cannula 105 therein. The guide tube 125 may be compressible. The guide tube 125 may be a commercially available guide tube. The guide tube 125 may be the sole/only device of the fixture system 100 that comes into direct contact with the cannula 105. For example, the guide tube 125 may already be provided with the cannula 105 upon delivery or it may be available as an accessory.

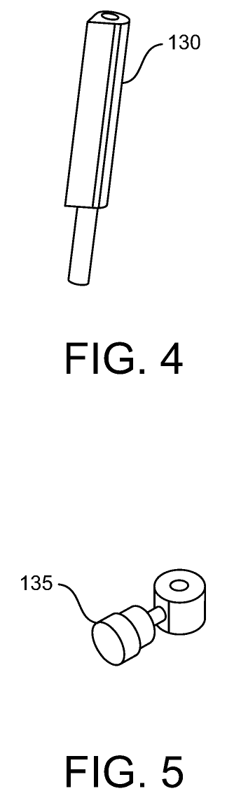

With reference again to FIG. 1, the guide tube 125 is removably positioned in a guide element or guide adapter 130, which is attachable to the frame 110. FIG. 4 shows the guide adapter 130, which is an elongate body that removably receives the guide tube 125. As shown in FIG. 1, the guide adapter 130 connects to the frame 110 such that it mechanically couples to and extends through the upper platform 112. The guide adapter 130 is placed into the frame 110 during use, as described more fully below. The fixture may not need a guide adapter and/or guide tube. Instead, the guide tube and/or depth stop and/or cannula may interact directly with the frame and other features.

With reference still to FIG. 1, the fixture system 100 further includes a position stop, such as a depth stop 135, which is configured to adjustably secure the cannula 105 relative to the frame 110 such that the cannula 105 is fixed relative to the frame and is prevented from traveling distally beyond a certain distance along the prescribed trajectory. The depth stop 135 can be used to hold the cannula 105 at a predetermined distance relative to the vial 120 such as a predetermined ‘height’ relative to the vial along the trajectory. The depth stop 135 may be a separate accessory that is placed on the guide tube 125 or onto the cannula 105. FIG. 5 shows the depth stop 135, which is a clamp, collet, tube or other structure that can be compressed to secure the depth stop to the guide tube 125/cannula and secure the position. The depth stop may be incorporated into another component such as the guide tube or guide adapter. The locking mechanism may be a thumb screw, collet or any other mechanism.

The fixture system 100 also includes a mechanism for adjusting the height of the cannula 105 relative to the vial 120. In an example implementation, the frame 110 has one or more mechanical features at locations that correspond to various predetermined heights of the cannula 105 relative to the vial 120. The guide adapter 130 has corresponding features that interact with the frame 110 at such locations. A user can adjust how the guide adapter 130 is configured to select or interact with the desired height location. For example, the user can start in the “0mm” position and lock the cannula in place. The user can then rotate the guide adapter and place it into the “1.0mm” position to raise the cannula by 1mm.

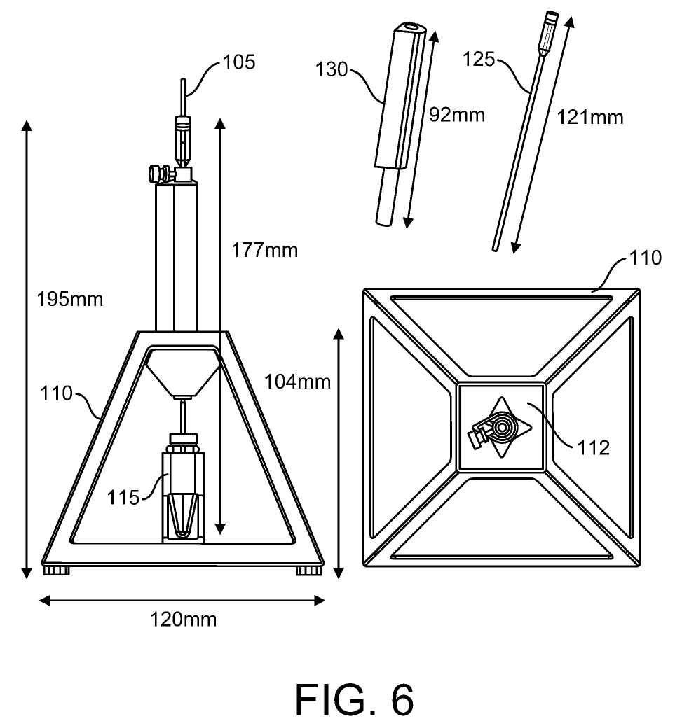

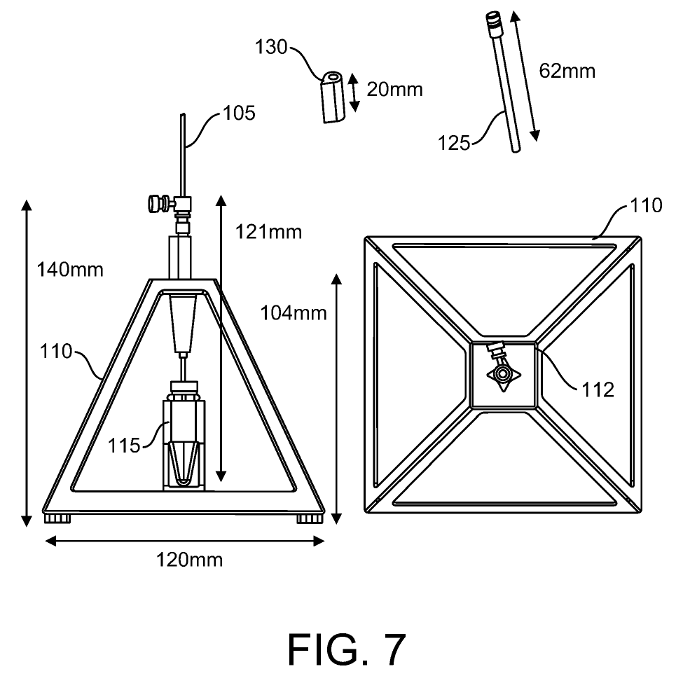

FIGS. 6 and 7 show various views of the components of the fixture system 100 including example, non-limiting dimensions.

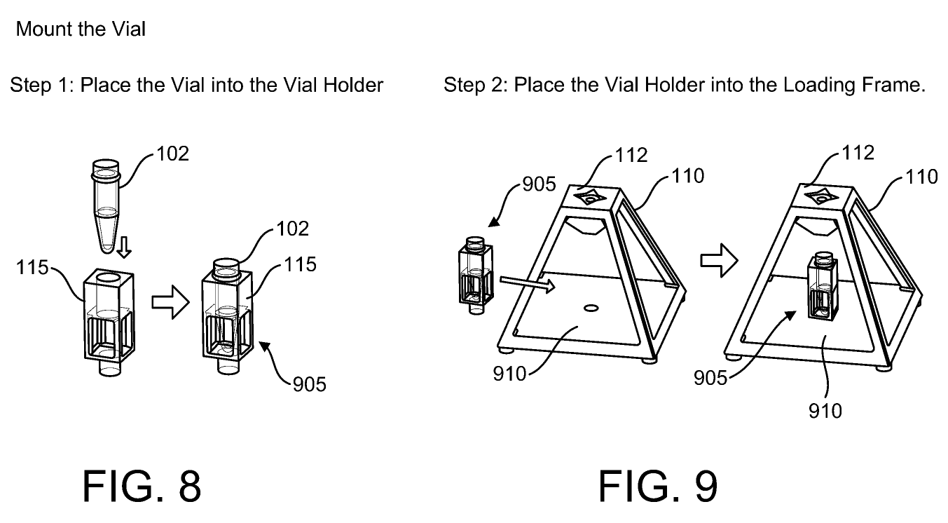

An example workflow for the system 100 is now described with reference to FIGS. 8-14. The workflow is described in an example context of positioning the cannula 105 to interact with the vial 102 for cannula loading such as loading a therapeutic into the cannula 105. Other workflows are within the scope of this disclosure, such as for storage, sterilization, transport, etc. of the cannula. Also, the workflow is a non-limiting example such that steps may be performed in a different order, not all steps are necessary, and additional steps may be added.

With reference to FIG. 8, a user places the vial 102 into the vial holder 115 to form a vial assembly 905 formed of the vial holder 115 with the vial 102 contained therein in a fixed position relative to the vial holder. The vial assembly 905 may be provided in a pre-assembled state to a user.

With reference to FIG. 9, the vial assembly 905 is then placed within the frame 110 such as on a base platform 910 of the frame 110. The vial assembly 905 is thus fixedly positioned below the upper platform 112 of the frame 110 such as in a predetermined position.

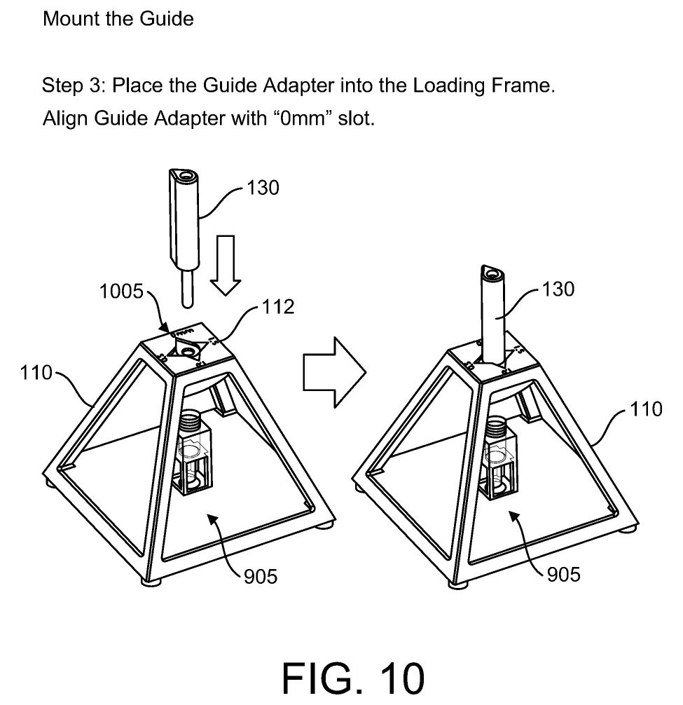

With reference to FIG. 10, the guide adapter 130 is then loaded or otherwise attached to the frame 110, such as by inserting the guide adapter 130 into a complementary-shaped slot 1005 or other opening in the upper platform 112. In this manner, the guide adapter 130 is fixedly positioned on and mounted to the frame 110. The guide adapter 130 is positioned so that a long axis of the internal lumen of the guide adapter 130 aims along a trajectory that points toward the vial of the vial assembly 905 such as toward an opening of the vial.

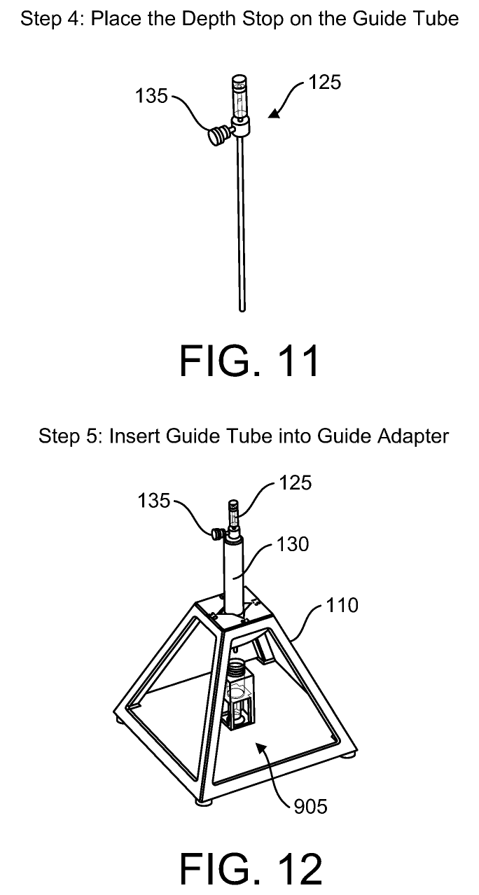

With reference to FIG. 11, the depth stop 135 is attached to the guide tube 125 such as to a proximal region of the guide tube 125. The guide tube 125 is then inserted into the guide adapter 130, which is fixedly mounted on the frame 110, as shown in FIG. 12.

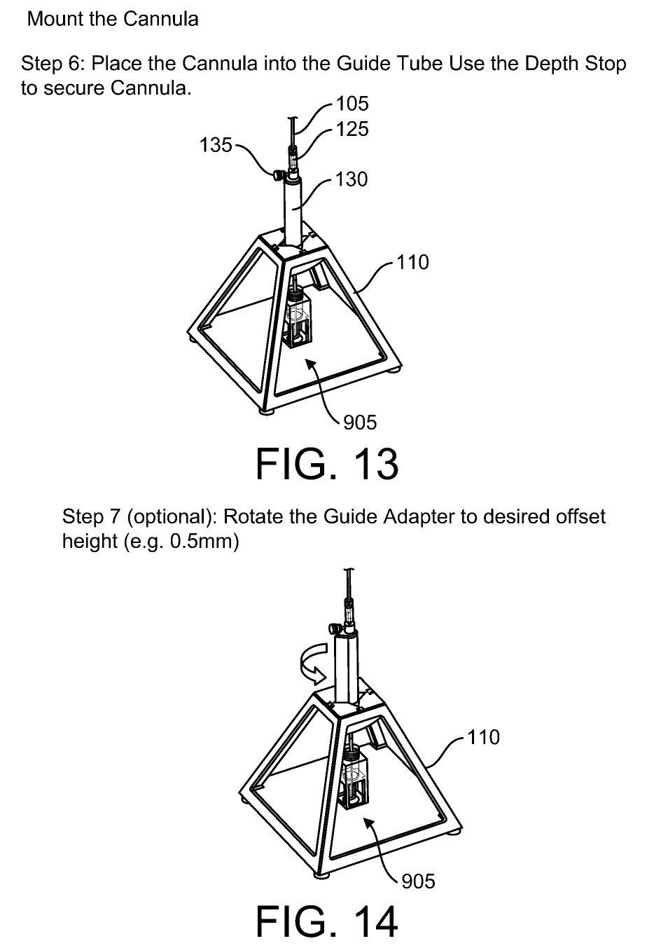

Next, as shown in FIG. 13, the cannula 105 is place into the guide tube 125. The depth stop 135 is then tightened, which compresses the guide tube 125 to secure the cannula 105 in place relative to the guide adapter 130. This also secures the trajectory of the cannula 105 toward the vial. In an optional step shown in FIG. 14, the guide adapter 130 can be actuated, such as via rotation, to select and set an offset height between a distal tip of the cannula 105 and the vial. The amount of offset can vary. In some non-limiting examples, the offset is 0mm, 0.3mm, 0.5mm, 1mm, or 1.5mm. The fixture may allow for different heights or a different quantity of user selectable options. A user actuates the guide adaptor 130 to slidingly move the distal tip of the cannula 10 relative to the cannula along the long axis of the cannula to adjust the offset height between the distal tip of the cannula 105 and the vial (such as to a predetermined landmark of the vial.)

With reference still to FIG. 14, in an example implementation the height adjustment mechanism comprises a guide tube offset feature wherein a user can rotate the guide tube to interact with different height features on the frame or guide adapter. The frame 110 includes a plurality of engagement features disposed on surface 112, the engagement features having different effective heights relative to a reference direction with which the guide adaptor is pointed. The guide adapter 130 includes an engagement member movable relative to the frame 110, the engagement member being selectively engageable with one of the engagement features via rotation of the guide adapter 130. Engagement of the engagement member with a user-selected engagement feature retains the guide adapter 130 at a corresponding height position relative to the vial, thereby adjusting the cannula height according to the selected engagement feature. For example, the engagement member may be a protrusion of the guide element that engages with a complementary shaped cutout on the frame. The guide element rotates relative to the frame so as to interacts with different features on the frame such that each feature corresponds to a different height.

The system and workflow align the cannula 105 precisely relative to the vial 102, such as with a distal tip inside of the vial 102. This ensures the distal tip is at the desired location and does not get damaged from unintended interactions (e.g. lateral forces.) The fixture system 100 can be used for front-loading the cannula 105 (e.g. aspirating therapy into the distal tip of the cannula). The fixture system 100 can also be used to hold the cannula 105 in air or in a vial between uses. This may be useful to help preserve the therapy at optimal conditions between cannula uses. The fixture system holds the vial and allows for managing the sterile field while interacting with a non-sterile vial. The fixture system also enables precise height control to keep the cannula distal tip submerged in the vial even with small volume of liquid/therapy in the vial. Moreover, the fixture system 100 keeps the cannula 105 in a controlled orientation (such as a vertical orientation) before/between/after uses, which may be advantageous to preserve the therapy at optimal conditions. The fixture system also reduces the need for additional people to hold the cannula and/or vial while a first person aspirates. This also facilitates a simpler and more controlled workflow with less risk of damage to the cannula.

Although the figures show the guide adapter 130 and cannula 105 positioned in a vertical orientation with a vertical trajectory, it should be appreciated that the orientation can be horizontal, tilted, angled relative to the vertical, or any other orientation that can be pre-set or determined by a user. Furthermore, although the system is shown and described as fixedly mounting the cannula 105 and the vial 102, the system may be configured to hold only the cannula and no vial.

The system is shown and described as being compatible with a “reducing tube” style device tube. It should be appreciated the system may be compatible with a variety of other accessories (e.g. targeting cannula) or have no separate guide adapter. The device may also incorporate materials and features into the guide adapter to facilitate biocompatibility (e.g. use same materials that are used in commercially available guide tubes.)

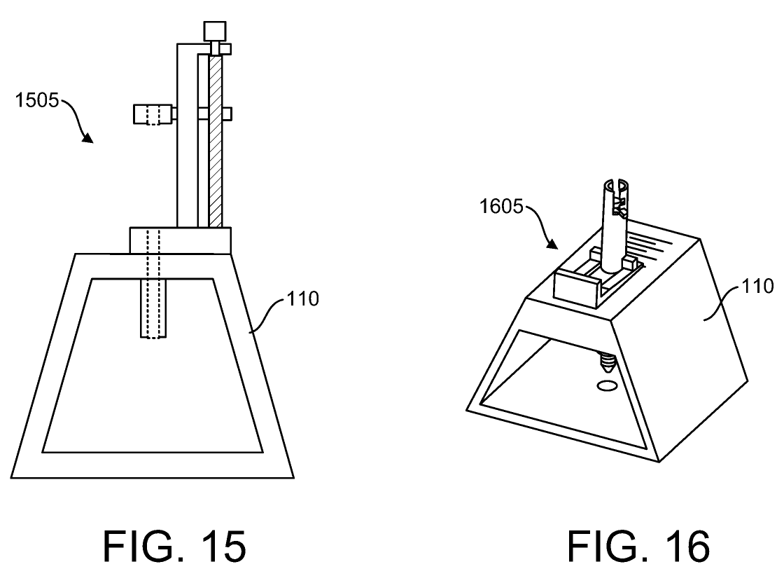

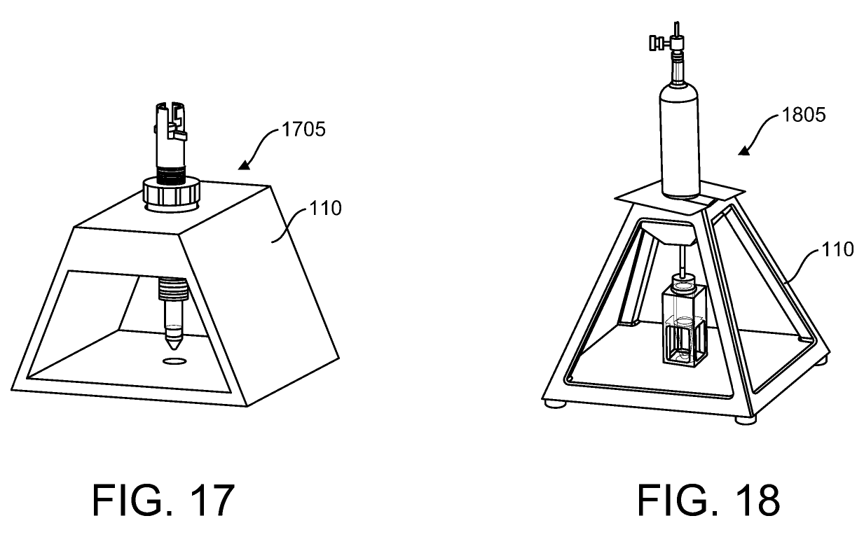

The fixture system 100 may utilize different mechanisms for adjusting the cannula height. For example, FIG. 15 schematically shows the frame 110 coupled to a height adjustment mechanism comprised of a Microdrive assembly 1505. In another implementation shown in FIG. 16, the height adjustment mechanism comprises a sliding wedge assembly 1605 that includes a slidable wedge that can be slid relative to the cannula to modify the wedged thickness and selectively permit a position adjustment (such as a height adjustment.) FIG. 17 shows an implementation wherein the height adjustment mechanism comprises a Z-axis adjustor assembly 1705 formed of a lead screw or other mechanism incorporated into the frame 110. FIG. 18 shows an implementation wherein the height adjustment mechanism comprises a removable shim assembly 1805 wherein a shim is placed between the frame and guide adapter to selectively allow for height adjustment based upon sliding movement of the shim. Other example height adjustment mechanisms include a set screw other feature that is adjusted up or down to adjust the height. In another example, the height adjustment mechanism comprises a guide tube offset wherein the guide tube is rotated to interact with different height features on the frame or guide adapter, as shown above with reference to FIG. 14. The height adjustment can also be accomplished through a manual process wherein a user must manually adjust the height, and no special features are incorporated into the fixture to facilitate this. In another implementation, height adjustment is not available and the cannula 105 is locked into the frame 110 at a fixed height.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results. Only a few examples and implementations are disclosed. Variations, modifications and enhancements to the described examples and implementations and other implementations may be made based on what is disclosed.

1. A system for fixedly positioning a medical device relative to a target device, the system comprising:
a frame having a mounting location for mounting the medical device in a position relative to the frame such that the medical device extends along a predetermined trajectory and a portion of the medical device is positioned in a fixed, predetermined position relative to the target device;
a guide element that attaches to or is incorporated in the frame and to the medical device, the guide element configured to attach the medical device to the mounting location of the frame in the position.

2. The system of claim 1, further comprising a position adjustment mechanism that adjusts a position of the portion of the medical device relative to the target device.

3. The system of claim 2, wherein the position adjustment mechanism adjusts a height of the portion of the medical device.

4. The system of claim 2, wherein the portion of the medical device is a distal tip of the medical device and the position adjustment mechanism adjusts a position of the distal tip relative to the target device.

5. The system of claim 2, further comprising a position stop configured to secure the medical device relative to the frame and prevent the medical device from traveling distally beyond a certain distance along the predetermined trajectory.

6. The system of claim 2, wherein the position adjustment mechanism comprises a microdrive.

7. The system of claim 2, wherein the position adjustment mechanism comprises a lead screw.

8. The system of claim 2, wherein the position adjustment mechanism comprises a shim.

9. The system of claim 2, wherein the position adjustment mechanism comprises a set screw.

10. The system of claim 1, wherein the guide element comprises sheath that receives the medical device.

11. The system of claim 1, wherein the frame is a truncated pyramid.

12. The system of claim 1, wherein the medical device is a cannula and the target device is a vial.

13. The system of claim 1, wherein the medical device is a biopsy needle, a laser applicator, or an Intravascular Ultrasound (IVUS) catheter.

14. The system of claim 1, further comprising a position adjustment mechanism that aligns the portion of the medical device to a feature of the target device such that the portion of the medical device interfaces to a specific location of the target device.

15. The system of claim 14, wherein the portion of the medical device is a distal tip of the medical device and the target device is a vial, and wherein the position adjustment mechanism aligns the distal tip of the medical device at a specific distance relative to the medical vial.

16. The system of claim 15, wherein the specific distance is a height.

17. The system of claim 1, wherein the guide element removably attaches to the frame.

18. The system of claim 1, wherein the guide element mechanically interacts with at least one feature on the frame such that a position of the guide element relative to the frame can be adjusted to selectively modify a height of the medical device in a controlled fashion.

19. The system of claim 15, wherein the at least one feature is a cutout or protrusion on an upper platform of the frame.

20. The system of claim 16, wherein the guide element rotates relative to the frame so as to interacts with different features on the frame such that each feature corresponds to a different height.
